(19) United States
(12) Patent Application Publication
(10) Pub. No.: US 2002/0154762 A1
(43) Pub. Date: Oct. 24, 2002

(54) Telephone connection box

(76) Inventors: Rainer Guenther, Bautzen (DE); Wolfgang Huschmann, Bautzen (DE); Jost Kawczyk, Loebau (DE); Peter Klimann, Radibor (DE); Heinz Dieter Hentschel, Bautzen (DE)

Correspondence Address: Michael E Marion, Philips Electronics North America Corporation, 580 White Plains Road, Tarrytown, NY, 10591, US

(21) Appl. No.: 09/937,530

(22) PCT Filed: Jan. 17, 2001
(86) PCT No.: PCT/EP01/00484

(30) Foreign Application Priority Data
Jan. 25, 2000 (DE) 10002958.2

(51) Int. Cl. H04M 1/00; H04M 9/00

(52) U.S. Cl. 379/399.01

(57) ABSTRACT

The invention relates to a telephone connection box for an ISDN basic access. The telephone connection box comprises an electronic circuit of a network terminating device.

The invention relates to a telephone connection box for an ISDN basic access.

Such a telephone connection box is known, for example, from the title “Alles über Euro-ISDN” by Horst Frey and Detlef Schönfeld, Franzis-Verlag GmbH, Feldkirchen, 1996, pp. 82 to 97. The subscriber's lines of a switching center, which lead to a house connection, are then connected to sockets of the telephone connection box. Subscriber's lines run from the telephone connection box to a separate network terminating device. To sockets (S₀-interface) of the network terminating device can be connected ISDN terminal units.

It is an object of the invention to provide a telephone connection box for which less installation expenditure is needed.

According to the invention the object is achieved in that the telephone connection box contains an electronic circuit of a network terminating device.

The invention is based on the idea of integrating the function of a network terminating device (NTI) for the ISDN basic access (irrespective of the line code used) by suitable constructive measures in a connection box which is arranged as a concealed or surface-mounted socket. Such integration is possible when SMD components, integrated circuits with small housings and a DC-DC switching element having a high switching frequency are used. As a result of this integration, no additional network terminating device need be installed in addition to the connection box; the installation expenditure is reduced, the cabling is simplified and the cost of installation is decreased.

claim 2 describes the structure of the telephone connection box. Through an optional plug-in power supply (claim 3), which also has additional sockets (claim 4), the normal supply voltage can be fed to the S₀ interface. Via the subscriber's line signals of the S₀ interface can be applied to the sockets of the plug-in power supply.

These and other aspects of the invention are apparent from and will be elucidated with reference to the embodiments described hereinafter.

### IN THE DRAWINGS

FIG. 1 shows an inner portion of a telephone connection box with an integrated network terminating device,

FIG. 2 shows a screen that can be applied to the inner portion of the telephone connection box and

FIG. 3 shows a plug-in power supply that is connected to a socket of the telephone connection box via subscriber's lines.

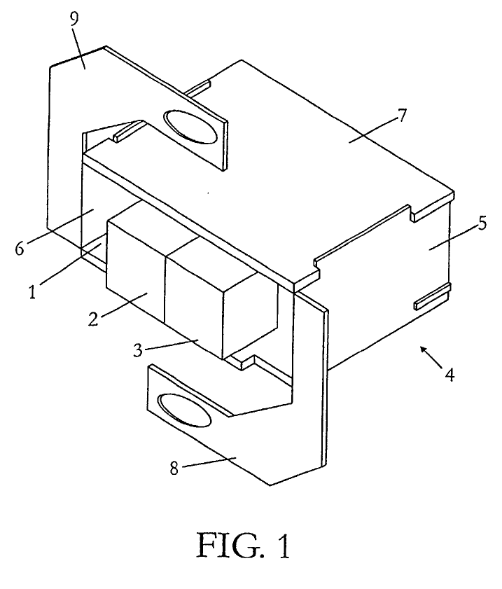

FIG. 1 shows an inner portion of a telephone connection box to be inserted into a recess in a wall. The telephone connection box shown in FIG. 1 is a concealed wall socket. The inner portion comprises a printed circuit board 1 on which two sockets 2 and 3 are found and various components (not further shown) of an electronic circuit. Further components of the electronic circuit are arranged on an opposite printed circuit board 7. The sockets 2 and 3 and the components have electrical connections which are soldered with the printed wiring on the printed circuit board. The electronic circuit, which comprises SMD components, integrated circuits with small housings and a DC-DC switch element with a high switching frequency, forms a network terminating device.

To the printed circuit board 1 is connected a metal frame 4 which enables a stable installation of the telephone connection box as a concealed socket. Two side portions 5 and 6 (metal) of the metal frame 4 abut at respective different narrow side faces of the printed circuit board 1 and are connected thereto. The two other side faces of the printed circuit board 1 thus lie against the metal frame which, on the one hand, enables a connection of the subscriber's lines from the switching center to the electronic circuit and, on the other hand, an access to the sockets 2 and 3. The two side portions 5 and 6 of the metal frame 4 are connected to the second printed circuit board 7 arranged in parallel with the printed circuit board 1. The printed circuit boards 1 and 7 are interconnected by an electric connector.

For fixing the telephone connection box, two more metallic L-shaped parts are provided as fixing parts 8 and 9. The fixing parts 8 and 9 have each two arms arranged at right angles. One arm of a fixing part 8 and 9 is attached to the narrow side of a side portion 5 and 6, so that the planes of the side portion 5 and of the fixing part 8 on the one hand, and of the side portion 6 and of the fixing part 9 on the other form a right angle outside the metal frame. The arms of the fixing parts 8 and 9 not attached to the side portions 5 and 6 are arranged so that the right angle shows in the direction of the sockets. The two arms of a fixing part 8 and 9 contain punched holes to accommodate screws for locking the telephone connection box. Both the side portion 5 and the fixing part 8 and the side portion 6 and the fixing part 9 may be punched from a piece of metal and be folded accordingly.

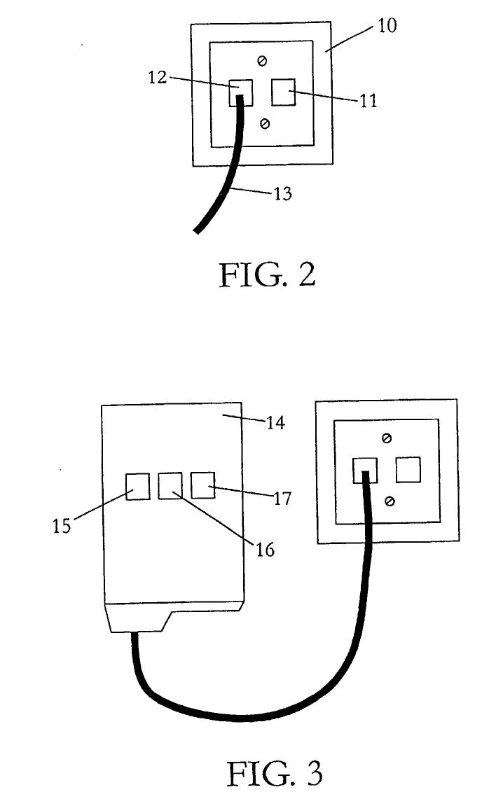

FIG. 2 shows a screen 10 having two openings 11 and 12 for the sockets 2 and 3. This screen 10 is screwed onto the inner portion of the connection box. As further shown in FIG. 2, a line 13 with a respective plug runs from the telephone connection box to an ISDN terminal unit (telephone, telefax, ISDN card, and so on) (not further shown here). The sockets of the telephone connection box are the So interfaces of the network terminating device. For a fully concealed version the line may also be connected directly to the printed circuit board 1.

In nearly all cases the 420 mW supply power of the network terminating device is sufficient for emergency operation in case of network failure, because most ISDN terminal units have power supplies of their own. The emergency supply voltage is then provided by the switching center. If, however, a 4.5 watt power supply is necessary (normal power supply), a plug-in power supply is necessary. The plug-in power supply then supplies the supply voltage to the network terminating device via a line to a socket 2 or 3.

The network terminating device comprises a detector circuit (not further shown), which detects whether there is a voltage having the polarity of the “normal mode” on the So interface (socket 2 or 3), which voltage is generated by the plug-in power supply or can also be fed by an ISDN terminal unit connected to the So interface. If a voltage is found supplied by the plug-in power supply or ISDN terminal unit, the voltage is detected by the detector circuit and this detector circuit separates the emergency supply voltage from the So interface, which voltage is derived from the voltage produced by the switching center.

The plug-in power supply may further include additional sockets. In FIG. 3 is shown such a plug-in power supply 14. This plug-in power supply includes additional sockets 15 to 17 for connecting further ISDN devices directly to the So bus. The plug-in power supply is thus not only used for generating a supply voltage, but also as an So distributor (sockets 15 to 17). For separating the supply voltage and the signals of the So interface, the plug-in power supply includes an additional electronic circuit (not further shown here).

The telephone connection box may also be arranged as a surface-mounted socket.

1. A telephone connection box for an ISDN basic access,
characterized in that the telephone connection box includes an electronic circuit of a network terminating device.

2. A telephone connection box as claimed in claim 1, characterized in that two printed circuit boards with electronic components and sockets form the network terminating device and in that the printed circuit boards are connected to a metal frame for being fixed to the wall.

3. A telephone connection box as claimed in claim 2, characterized in that a supply voltage of a plug-in power supply can be supplied via a socket to ISDN terminal units connected to the S₀ interface.

4. A telephone connection box as claimed in claim 3, characterized in that the plug-in power supply connected via at least one line to a socket includes additional sockets.
